(19) United States
(12) Patent Application Publication
(10) Pub. No.: US 2009/0312849 A1
(43) Pub. Date: Dec. 17, 2009

(54) AUTOMATED AUDIO VISUAL SYSTEM CONFIGURATION

(75) Inventors: John Elliot Cosgrove, Clemmons, NC (US); Frederick Pfohl Nading, JR., Cary, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB, Lund (SE)

(21) Appl. No.: 12/141,412

(22) Filed: Jun. 18, 2008

Related U.S. Application Data
(60) Provisional application No. 61/061,862, filed on Jun. 16, 2008.

(51) Int. Cl. H04R 5/02; G05B 13/02

(52) U.S. Cl. 700/28; 381/300; 345/207; 340/686.6

(57) ABSTRACT

Automated configuration of an audio-visual system is made by determining a configuration for the system based on positioning information corresponding to a location of a user. Determination may further account for ambient conditions, content presented via the system, performance characteristics of the system, physical attributes of the user, preferences of the user, or physical constraints of the system or surrounding environment. Configuration of the system is effectuated through automated bases configured to receive signals generated based on the determination, which can involve spatial configuration of one or more system components, e.g., translational displacement and rotational motion, and/or electronic reconfiguration of one or more system components, e.g., setting adjustments. Users can modify or override configuration at any time.

### BACKGROUND

The present invention relates to audio visual systems, more particularly to automated configuration of audio visual systems.

Audio visual (AV) systems, such as multimedia home entertainment systems, AV systems of theaters, arenas, etc., are known. These systems typically include various peripheral devices that enable users to experience a diversity of multimedia content within a litany of spaces or environments. For instance, a conventional AV system may include a display unit (e.g., television, monitor, screen, etc.) coupled to one or more of a digital versatile disk (DVD) player, a video cassette recorder (VCR), a personal video recorder (PVR), an AV receiver, a television broadcast receiver (e.g., a cable, fiber-optic, or satellite receiver), a multichannel surround sound system, and/or a gaming system, as well as any other suitable AV input or output device. Conventional AV systems are typically installed in and, thereby, distributed about various operating environments (e.g., homes, businesses, convention centers, pavilions, theaters, etc.) so as to maximize viewing and listening experiences of users at the largest amount of potential vantage points. This often results in an overall configurations that are “optimal” for a space, but “suboptimal” for many (if not all) of the specific vantage points. Given the size and permanent installation of conventional AV system components, repositioning peripheral devices for optimal performance at specific vantage points becomes arduous, if not wholly unavailable.

Moreover, AV components typically provide multiple user definable settings. For example, multichannel surround sound systems can be customized to produce idiosyncratic virtual sound fields. Televisions can be adjusted to provide personalized display characteristics (e.g., brightness, sharpness, etc.). Establishing and reconfiguring these components become subjective processes that are typically performed by inexperienced users through manual, repetitive trial and error procedures. As such, consistent, repeatable AV system configuration is difficult to obtain, much less maintain.

Accordingly, a need exists for automated configuration tools and methodology that enable AV systems to automatically optimize peripheral device configurations. There exists a particular need for such tools and methodology that enable automated AV system configurations based on user positioning. Further benefits can be achieved through automated configuration technologies that account for ambient conditions, environment limitations, user eccentricities, and/or content modalities.

### DISCLOSURE

The above described needs are fulfilled, at least in part, by obtaining positioning information data corresponding to a location of a user, determining a spatial configuration for an audio visual system based on the positioning information data, and generating a signal for spatially reconfiguring one or more components of the audio visual system in accordance with the generated signal. Determination of the spatial configuration can be based on a performance characteristic of the system, such as effects of audio and video implementation. Spatial reconfiguration will improve or optimize the user's audio or visual experience.

The positioning information data may be generated in real-time at a location proximate the user. Detection of the user's presence can initiate retrieval of user profile information correlating the user with one or more system audio and/or visual parameters. Correlation may include user preferences, user physical attributes, or other criteria. Spatial reconfiguration may involve translational displacement and/or rotation of a system component, or combination of components.

Any physical constraint information associated with the audio visual system environment may be received and evaluated in the reconfiguration determination. Detection of an ambient environmental condition can also be factored in such evaluation. Reconfiguration can be modified or overridden in accordance with a user input command.

A system controller includes a processor and communication interface. A positioning module is provided to resolve positioning of the user in real-time upon receipt of wireless signals from a wireless transmitter proximate the user. The processor determines a spatial configuration for the audio visual system based on user position. A controller receiver can provide for detection of the proximity of the wireless transmitter. A memory, coupled to the processor, may be used to store user profile information. A sensor may be coupled to the processor to detect an ambient environmental condition.

Additional advantages of the present invention will become readily apparent to those skilled in this art from the following detailed description, wherein only the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawing and in which like reference numerals refer to similar elements and in which:

FIG. 1 is a schematic illustration of an audio visual system, according to an exemplary embodiment;

FIG. 2 is a schematic illustration of an automated base for supporting a display unit, according to an exemplary embodiment;

FIG. 3 is a schematic illustration of an automated base for supporting an audio unit, according to an exemplary embodiment;

FIG. 4 is a schematic illustration of a control unit of an automated base, according to an exemplary embodiment;

FIG. 5 is a schematic illustration of an audio visual receiver, according to an exemplary embodiment;

FIG. 6 is a schematic illustration of a wireless terminal, according to an exemplary embodiment;

FIG. 7 is a flowchart of a process for creating an automated audio visual system user profile, according to an exemplary embodiment;

FIGS. 8 and 9 are flowcharts of a process for transmitting configuration signals to automated bases, according to various exemplary embodiments;

FIG. 10 is a flowchart of a process for configuring a component of an automated audio visual system, according to an exemplary embodiment; and

FIGS. 11 and 12 are schematic illustrations of configured automated audio visual systems, according to various exemplary embodiments.

### DETAILED DESCRIPTION

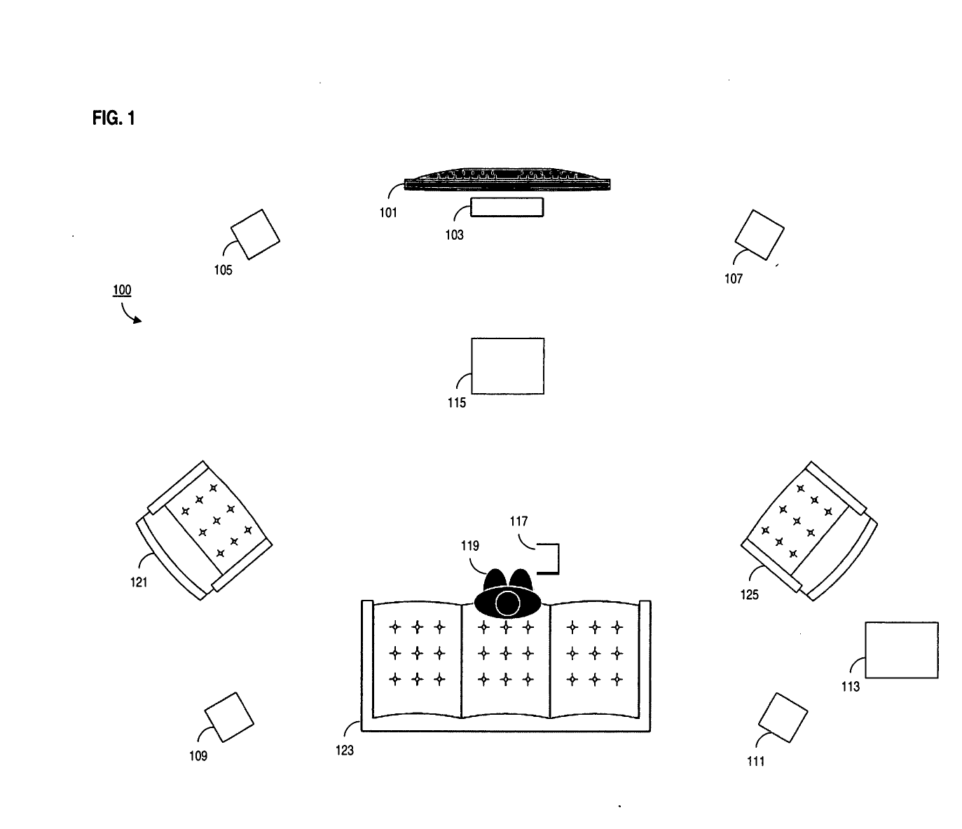

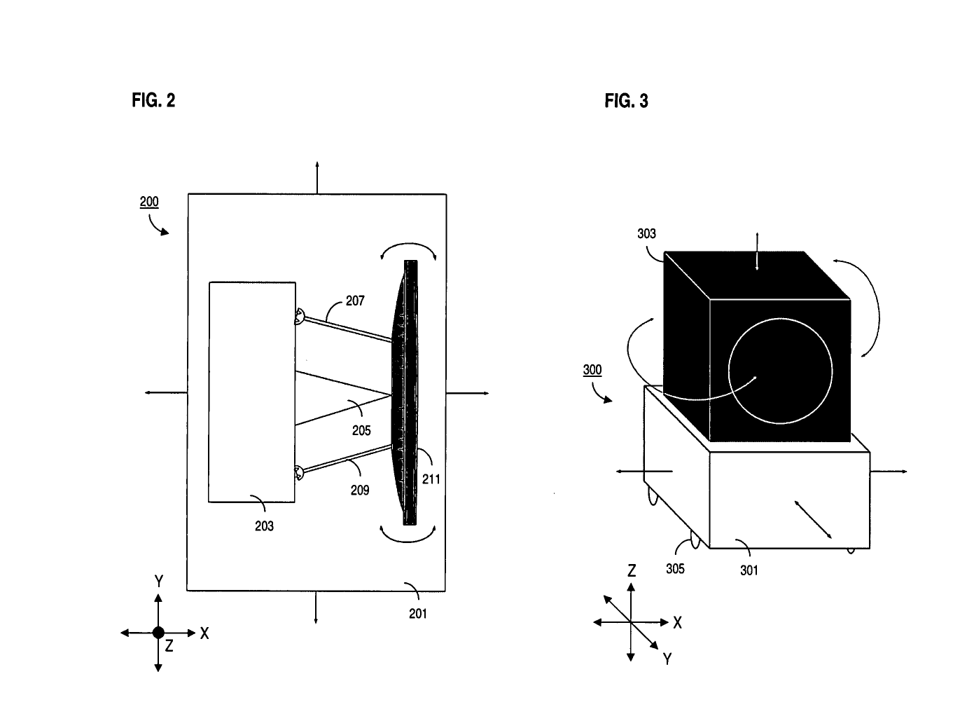

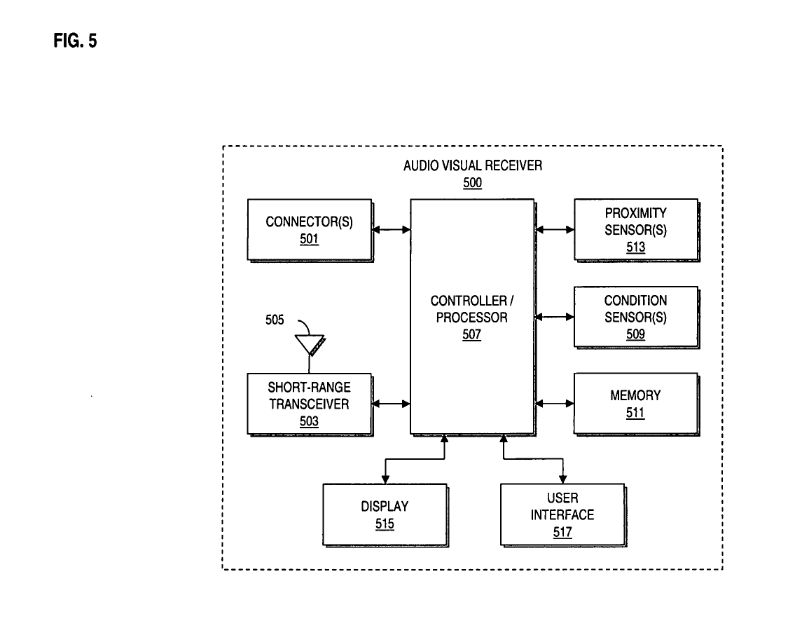

FIG. 1 is a schematic illustration of an audio visual (AV) system, according to an exemplary embodiment. AV system 100 includes a display unit 101, an audio system including a plurality of speakers (e.g., speakers 103, 105, 107, 109, 111, and 113), and an AV receiver 115. AV receiver 115 is described in more detail with FIG. 5. Display unit 101 may be any suitable video output device, such as a monitor, projector, television, screen, or the like. While only one display unit is shown, multiple display units are also feasible. The audio system may be any suitable stereo or multichannel system. As shown, the audio system is a 5.1 channel audio system including a center speaker 103, a front left speaker 105, a front right speaker 107, a left rear speaker 109, and a right rear speaker 111, and a subwoofer 113. It is contemplated, however, that the audio system may include any number of speakers. Display unit 101 and speakers 103-113 are individually supported through corresponding automated bases (not shown) capable of spatially and/or electronically configuring these peripheral devices. Exemplary automated bases are more fully described in association with FIGS. 2-4.

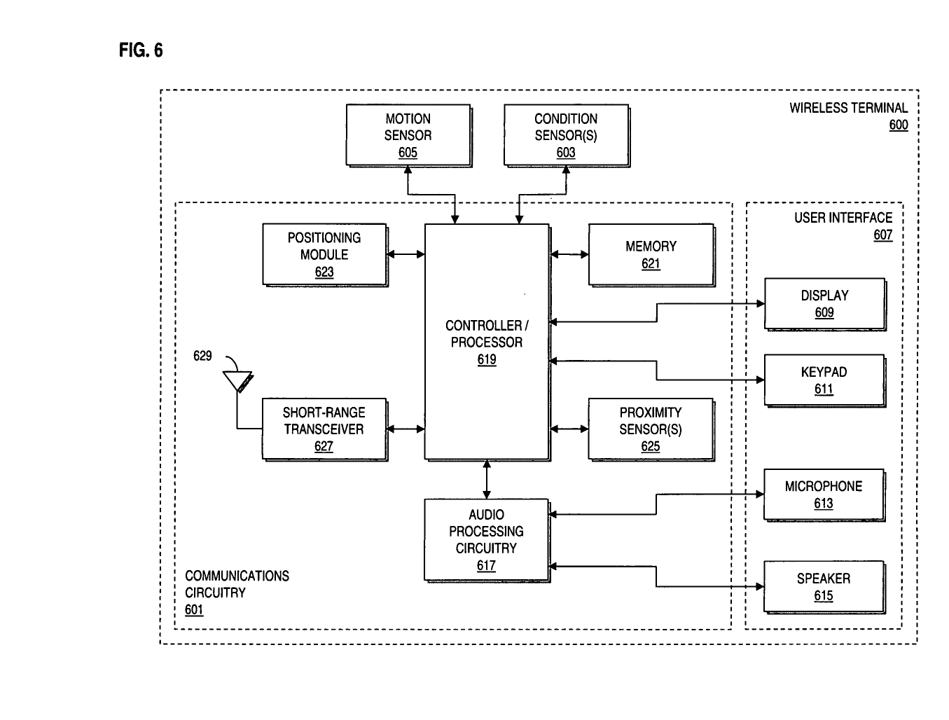

In exemplary embodiments, AV system 100 also includes a remote control device 117, such as a wireless terminal, which can be associated with a particular user 119. An exemplary wireless terminal is more fully explained in conjunction with FIG. 6. AV system 100 may also be obstructed by one or more physical impediments, such as seats 121, 123, and 125; however, any other impediments, e.g., individuals, plants, walls, etc., may also obstruct the environment of system 100. In this manner, AV system 100 may correspond to any suitable AV system, such as a public or private entertainment (or theater) system, an AV system of a live performance (e.g., concert, convention, performing art, sporting event, etc.), etc. Accordingly, exemplary embodiments enable the components of AV system 100 to be spatially and/or electronically configured to account for various audiences, AV effects, content being presented or performed, environments (e.g., convention centers, businesses, halls, pavilions, rooms, sets, stages, theaters, etc.), presenters or performers, etc.

FIG. 2 is a schematic illustration of an automated base for supporting a display unit, according to an exemplary embodiment. Automated base 200 includes chassis 201, mounting tower 203, support 205, and articulated arms 207 and 209 for supporting display unit 211. Chassis 201 provides translational displacement in an imaginary XY-plane. While not shown, chassis 201 may also enable rotational motion within the imaginary XY-plane, i.e., about an imaginary central axis parallel to an imaginary Z-direction. One or more movement mechanisms (not shown) can be disposed at an undercarriage of chassis 201 for providing the displacement and rotation functions. Movement mechanism(s) may include one or more spheres, tracks, wheels, etc., or combinations thereof.

Mounting tower 203 extends from chassis 201 and is configured for automated extension and retraction in a direction substantially parallel to the imaginary Z-direction. Extension and retraction functions may be provided by one or more telescopic tower sections (not shown) or any other suitable elevation mechanism. While not illustrated, mounting tower 203 may also provide rotational motion within an imaginary XY-plane, i.e., about an imaginary central axis parallel to the imaginary Z-direction.

In particular implementations, display unit 211 is supported and/or cantilevered from mounting tower 203 via support 205 and/or articulated arms 207 and 209. Support 205 may abut against or couple to display unit 211. In either instance, support 205 may include one or more links connected by one or more joints that enable display unit 211 to pivot about an imaginary axis of support 205. This imaginary axis extends in a direction parallel to an imaginary X-direction and may be an imaginary central axis of support 205.

Articulated arms 207 and 209 couple to display unit 211 and include one or more links connected by one or more joints. In this manner, articulated arms 207 and 209 enable three-dimensional rotational motion of display unit 211. Particularly, articulated arms 207 and 209 enable display unit 211 to tilt from an imaginary plane parallel to an imaginary YZ-plane. That is, display unit 211 may rotate about both an imaginary axis parallel to the imaginary Z-direction and an imaginary axis parallel to an imaginary Y-direction. In particular embodiments, articulated arms 207 and 209 also enable display unit 211 to rotate within the imaginary plane parallel to the imaginary YZ-plane, i.e., rotate about an imaginary axis parallel the imaginary X-direction. While described as articulated, arms 207 and 209 may also be unarticulated. Accordingly, arms 207 and 209 may embody any suitable robotic manipulator, such as a Cartesian manipulator, a gantry manipulator, a cylindrical manipulator, a spherical (or polar) manipulator, a selective compliance assembly manipulator, a parallel manipulator, etc., as well as combinations thereof. Furthermore, it is contemplated that any number of arms to support and manipulate display unit 211 may be provided.

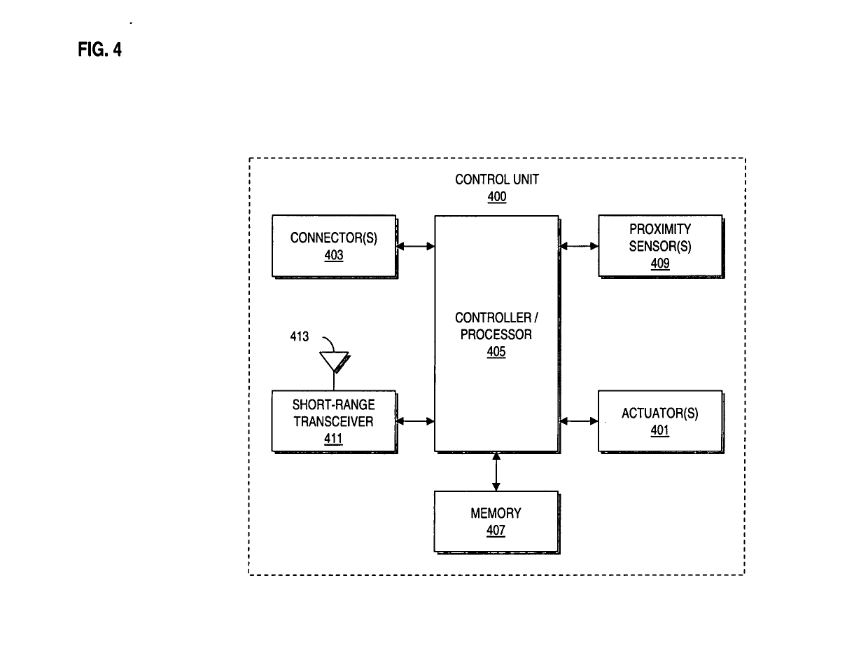

While not illustrated in FIG. 2, automated base 200 can include other components, such one or more actuators, one or more connectors, a controller (or processor), a memory, one or more proximity sensors, and a short-range transceiver coupled to an antenna. These additional components are described in more detail in accordance with FIG. 4; however, may be provided for controlling the translational displacement and rotational motion the components of automated base 200. In certain embodiments, these components may be utilized for establishing communications between components of AV system 100 and automated base 200. According to other embodiments, automated base 200 may be provided as a fixed structure (e.g., wall mount) having one or more articulated arms (e.g., articulated arms 207 and 209) for effectuating translational displacement or rotational motion of display unit 211.

FIG. 3 is a schematic illustration of an automated base for supporting an audio unit, according to an exemplary embodiment. Automated base 300 includes chassis 301 for supporting audio unit 303, e.g., a speaker. Chassis 301 provides translational displacement in an imaginary XY-plane. While not shown, chassis 201 may also enable rotational motion within the imaginary XY-plane, i.e., about an imaginary central axis parallel to an imaginary Z-direction. One or more movement mechanisms 305 can be disposed at an undercarriage of chassis 301 for providing the displacement and rotation functions. While movement mechanisms 305 are shown as wheels, it is contemplated that movement mechanisms 305 may embody one or more spheres, tracks, etc., or combinations thereof. According to one embodiment, chassis 301 also enables extension and retraction in a direction substantially parallel to the imaginary Z-direction. Extension and retraction functions may be provided by one or more telescopic chassis sections (not shown) or any other suitable elevation mechanism. Chassis 301, in certain embodiments, may also provide for non-uniform elevation of audio unit 303. That is, audio unit can be made to rotate from an imaginary XY-plane about an imaginary axis parallel to an imaginary Y-direction or an imaginary axis parallel to an imaginary X-direction.

While not illustrated in FIG. 3, automated base 300 can include other components, such one or more actuators, one or more connectors, a controller (or processor), a memory, one or more proximity sensors, and a short-range transceiver coupled to an antenna. These additional components are described in more detail in accordance with FIG. 4; however, may be provided for controlling the translational displacement and rotational motion of automated base 300. In certain embodiments, these components may be utilized for establishing communications between components of AV system 100 and automated base 300. According to other embodiments, automated base 300 may be provided as a fixed structure (e.g., wall mount) having one or more articulated arms (e.g., articulated arms 207 and 209) for effectuating translational displacement or rotational motion of audio unit 303. It is further contemplated that audio unit 303 can be supported and manipulated by automated base 200.

FIG. 4 is a schematic illustration of a control unit of an automated base, according to an exemplary embodiment. Control unit 400 of an automated base, such as automated base 200, includes one or more actuators (or motors) 401, one or more connectors 403, controller (or processor) 405, memory 407, one or more proximity sensors 409, and short-range transceiver 411 coupled to antenna 413. Actuators 401 manipulate the mechanical components of an automated base. For instance, within automated based 200, actuators 401 manipulate the displacement, extension, retraction, and rotation of chassis 201, mounting tower 203, and/or articulated arms 207 and 209. Within automated base 300, actuators 401 manipulate the displacement, extension, retraction, and rotation of chassis 301.

In order to prevent collision of automated base components, or collision of an automated base with an object (or other obstruction) of an environment of AV system 100, control unit 400 includes proximity sensors 409. Proximity sensors 409 detect the presence of “nearby” objects via, for example, distortions in generated electromagnetic or electrostatic fields, electromagnetic radiation (e.g., infrared, radio frequency, intermediate frequency, etc.) beams, photoelectric beams, sound (e.g., ultrasonic) propagations, etc. Controller 405 may be provided with sensed information from proximity sensors 409 to halt and/or redirect the course (e.g., displacement or rotation) of an automated base or the components thereof. In certain embodiments, proximity sensors 409 may be utilized to detect the presence of a user via interaction with a wireless terminal of AV system 100 (e.g., wireless terminal 117), as well as facilitate the determination of a location of a user via triangulation or other suitable positioning technique. In certain embodiments, controller 405 can utilize sensed information from proximity sensors 409 to “learn” the environment of AV system 100. This “learned” information may be further utilized to control an automated base.

Control unit 400 may also include one or more connectors 403 for establishing communications between control unit 400 and either a display unit (e.g., display unit 211) or an audio unit (e.g., audio unit 303). Connectors 403 may also be provided for communicatively coupling an automated base (e.g., automated base 200 and 300) to an AV receiver (such as AV receiver 500 described with respect to FIG. 5) via a wired connection. It is contemplated, however, that short-range transceiver 411 (e.g., a Bluetooth transceiver, an infrared transceiver, a wireless fidelity (WiFi) transceiver, a worldwide interoperability for microwave access (WiMAX) transceiver, etc.) may be utilized for wireless communications between an AV receiver and an automated base. In this manner, audio signals, visual signals, and/or AV configuration information (or commands) may be transmitted (via wired or wireless connection) to an automated base and then relayed to a corresponding audio unit or display unit using connectors 403.

Controller 405 controls the operation of an automated base according to programs and/or data stored to memory 407. Memory 407 may represent a hierarchy of memory, which may include both random access memory (RAM) and read-only memory (ROM). Computer program instructions, such as AV configuration application instructions, and corresponding data for operation can be stored in non-volatile memory, such as erasable programmable read-only memory (EPROM), electrically erasable programmable read-only memory (EEPROM), and/or flash memory. Memory 407 may be implemented as one or more discrete devices, stacked devices, or integrated with controller 405. Memory 407 may store information, such as one or more user profiles, one or more AV configuration parameters, one or more AV configuration modes, one or more predetermined AV configurations, etc. Memory 407 may also be utilized to store information about the environment of system 100. For instance, memory 407 may store information corresponding to one or more physical constraints of the environment, e.g., environment dimensioning, environment obstructions (e.g., seats 121-125), “learned” environmental information, wired components, wiring dimensions, etc. In certain embodiments, computer aided design files corresponding to the environment of system 100 may be stored to memory 407 and utilized by controller 405 to control an automated base or determine an AV system configuration.

Control functions may be implemented in a single controller or via multiple controllers. Suitable controllers may include, for example, both general purpose and special purpose controllers and digital signal processors. Controller 405 may interface with actuators 401 to control the displacement and rotation of an automated base (e.g., automated base 200 and 300). Controller 405 is also configured to receive configuration information via connectors 403 or short-range transceiver 411 for controlling actuators 401, i.e., the displacement and rotation of an automated base.

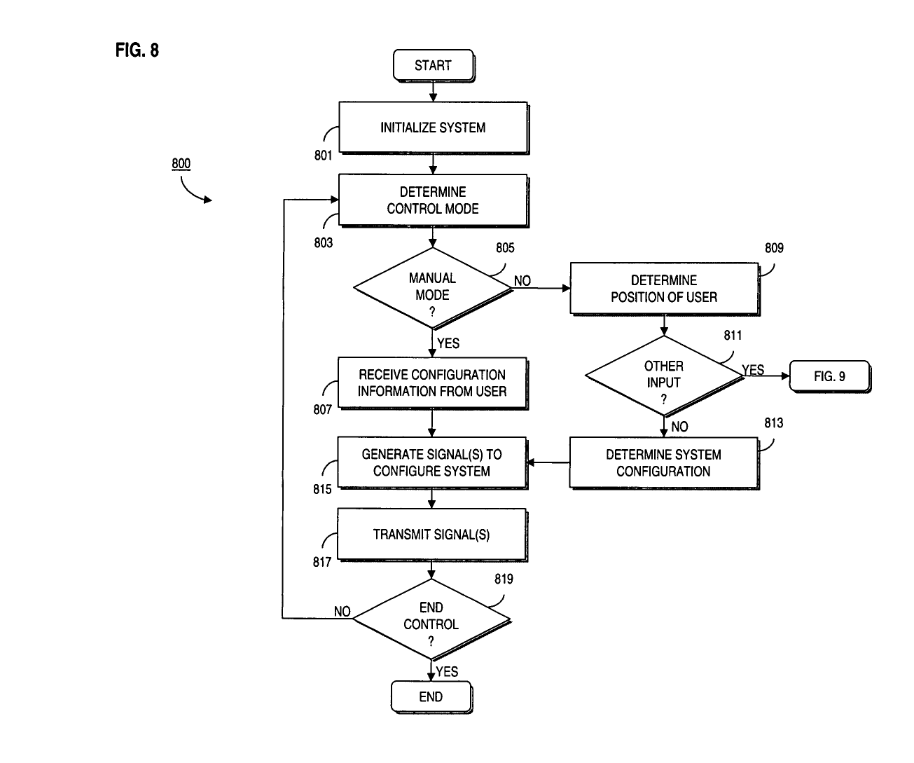

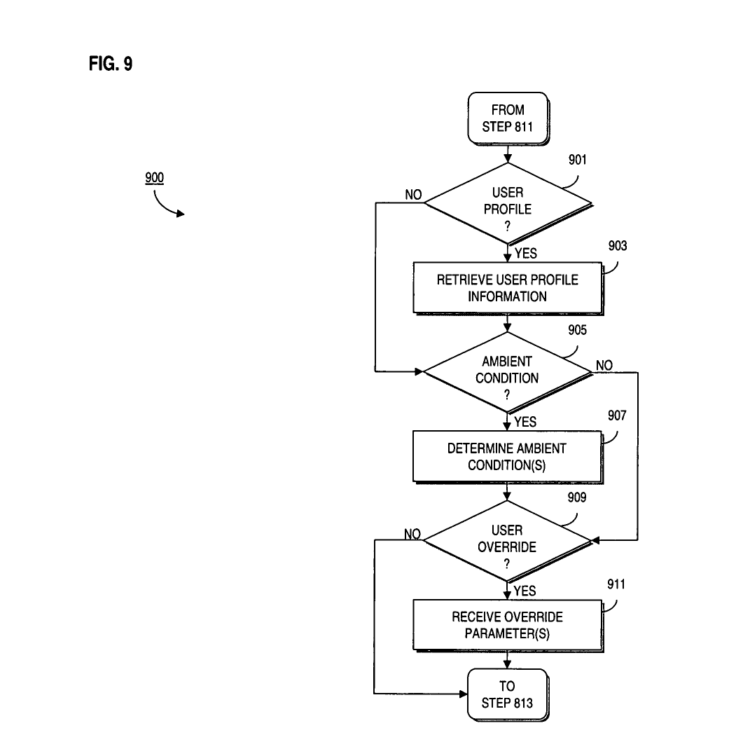

FIG. 5 is a schematic illustration of an audio visual receiver, according to an exemplary embodiment. In general, AV receiver 500 is configured to amplify audio output to, for example, speakers 103-113, and route video signals to display unit 101. AV receiver 500 can accept source input from various AV input components (not illustrated), such as a DVD player, VCR, PVR, a broadcast receiver, etc. In this manner, AV receiver 500 includes connectors 501 for wired communication to and from the AV components of AV system 100. It is noted; however, that wireless communication may be achieved via short-range transmitter 503 coupled to antenna 505. Short-range transceiver 503 may be a Bluetooth transceiver, an IR transceiver, IF transceiver, a WiFi, a WiMAX transceiver, etc., or a combination thereof. As such, AV receiver 500 may provide signal processing and conditioning functions via controller 507, which may in turn drive display unit 101 and/or the audio system of AV system 100. Short-range transceiver 503 may also be configured to receive information from a wireless terminal (e.g., wireless terminal 117) corresponding to user identification information. For example, the wireless terminal may communicate to AV receiver 500, via short-range transceiver 503, a user identification or code to identify the user to AV receiver 503. Identification of particular users may be utilized to further customize the spatial and/or electronic configuration of AV system 100, which will become more apparent in the description accompanying FIGS. 8 and 9.

According to particular embodiments, AV receiver 500 includes one or more condition sensors 509 for detecting one or more ambient conditions capable of affecting an optimum AV system viewing or listening experience. Condition sensor(s) 509 may include any suitable ambient condition sensor, such as, for instance, a light sensor for detecting ambient lighting, an audio sensor for detecting background noise levels or interference fields, etc. In other instances, condition sensors 509 may be utilized to assess performance characteristics of AV system 100, such as characteristics relating to a user viewing experience (e.g., display quality), a user listening experience (e.g., sound quality), etc. It is also noted that the performance characteristics may be related to or associated with the ambient conditions. Output from condition sensors 509 can be utilized by controller 507 to determine optimum AV system configurations. In other embodiments, user profile information may be retrieved from memory 511 based on one or more sensed conditions for automated AV system configuration.

AV receiver 500 can also include one or more proximity sensors 513 for detecting the presence of a user via interaction with a wireless terminal of AV system 100 (e.g., wireless terminal 117), as well as facilitate the determination of positioning of a user via triangulation or other suitable positioning technique. Proximity sensors 513 can detect the presence of “nearby” objects via, for example, distortions in generated electromagnetic or electrostatic fields, electromagnetic radiation (e.g., infrared, radio frequency, intermediate frequency, etc.) beams, photoelectric beams, sound (e.g., ultrasonic) propagations, etc. In certain embodiments, AV receiver 500 can utilize sensed information from proximity sensors 513 to “learn” the environment of AV system 100. This “learned” information may be further utilized to determine AV system configurations.

Controller 507 controls the operation of AV receiver 500 according to programs and/or data stored to memory 511. Memory 511 may represent a hierarchy of memory, which may include both RAM and ROM. Computer program instructions, such as AV configuration application instructions, and corresponding data for operation can be stored in non-volatile memory, such as EPROM, EEPROM, and/or flash memory. Memory 511 may be implemented as one or more discrete devices, stacked devices, or integrated with controller 507. Memory 511 may store information, such as one or more user profiles, one or more AV configuration parameters, one or more AV configuration modes, one or more predetermined AV configurations, as well as information corresponding to AV system 100 components, etc. Memory 511 may also store information corresponding to one or more physical constraints of the environment of AV system 100, e.g., environment dimensioning, environment obstructions, “learned” environmental information, ambient conditions, wired components, wiring dimensions, etc. In certain embodiments, computer aided design files corresponding to the environment of system 100 may be stored to memory 511 and utilized by controller 507 to control an automated base or determine AV system configurations.

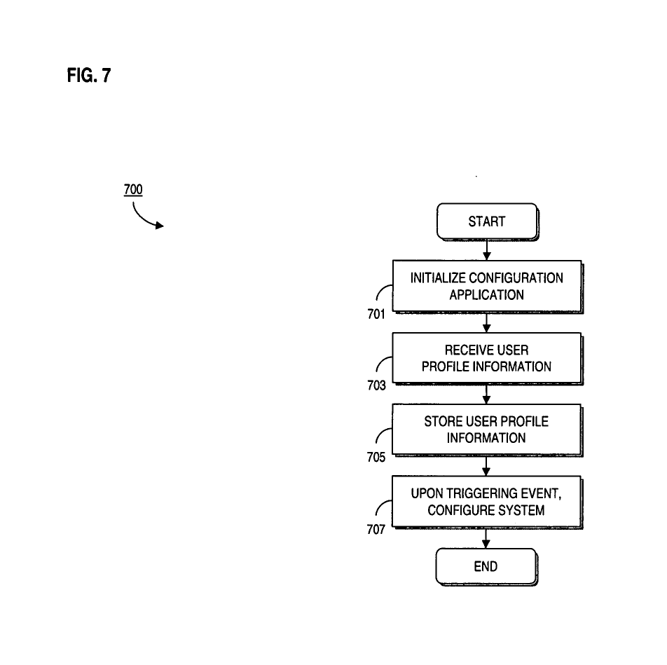

Control functions may be implemented in a single controller or via multiple controllers. Suitable controllers may include, for example, both general purpose and special purpose controllers and digital signal processors. Controller 507 may interface with a local display 515 and/or local user interface 517 (e.g., buttons, dials, joysticks, etc.) to facilitate the processes described herein. In certain embodiments, AV receiver 500 may alternatively or additionally utilize display unit 101 or input functionality of a wireless terminal of AV system 100. As will be described in more detail in connection with FIGS. 7-10, AV receiver may be configured to facilitate AV system 100 configuration.

FIG. 6 is a schematic illustration of a wireless terminal 600, according to an exemplary embodiment. As shown, wireless terminal 600 includes communications circuitry 601, condition sensor(s) 603, motion sensor 605, and user interface 607. User interface 607 includes display 609 and keypad 611. In particular implementations, user interface 607 may optionally include microphone 613 and speaker 615. Display 609 provides a graphical interface that permits a user of wireless terminal 600 to generate AV system configurations, input user profile information, and view menu options, as well as interact with other services. The graphical interface may include icons and menus, as well as other text and symbols. Keypad 611 includes an alphanumeric keypad and may represent other input controls, such as a joystick, button controls, dials, etc. Accordingly, a user can construct user profiles, enter commands, initialize applications, input AV system configuration information, and select options from menu systems. When available, the conjunction of microphone 613 and speaker 615 may provide an interface for voice recognition technology. That is, microphone 613 can be configured to convert spoken utterances of a user into electronic input audio signals, while speaker 113 may be configured to convert audio signals into audible sound outputs.

Communications circuitry 601 includes audio processing circuitry 617, controller (or processor) 619, memory 621, positioning module 623, sensor array 625, and short-range transceiver 627 coupled to antenna 629. While not shown, wireless terminal 600 may also include a long-range transceiver coupled to a corresponding antenna to facilitate other forms of communication, such as cellular, satellite, etc., communications. Short-range transceiver 627 may be configured to communicate with automated bases 200 and 300 and/or AV receiver 500. According to one embodiment, short-range transceiver 627 may communicate determined AV system configurations, control commands, or user profile or identification information.

Memory 621 may represent a hierarchy of memory, which may include both RAM and ROM. Computer program instructions, such as AV configuration application instructions, and corresponding data for operation can be stored in non-volatile memory, such as EPROM, EEPROM, and/or flash memory. Memory 621 may be implemented as one or more discrete devices, stacked devices, or integrated with controller 619. Memory 621 may store information, such as one or more user profiles, one or more user defined policies, one or more AV configuration parameters, one or more AV configuration modes, one or more predetermined AV configurations, etc. Memory 621 may also store information corresponding to one or more physical constraints of the environment of AV system 100, such as environment dimensioning, environment obstructions, “learned” environmental information, ambient conditions, wired components, wiring dimensions, etc. In certain embodiments, computer aided design files corresponding to the environment of system 100 may be stored to memory 621 and utilized by controller 619 to control an automated base or determine AV system configurations.

Controller 619 controls the operation of wireless terminal 600 according to programs and/or data stored to memory 621. Control functions may be implemented in a single controller or via multiple controllers. Suitable controllers may include, for example, both general purpose and special purpose controllers and digital signal processors. Controller 619 may interface with audio processing circuitry 617, which provides basic analog output signals to speaker 615 and receives analog audio inputs from microphone 613. Controller 619, as will be described in more detail below, is configured to execute an AV configuration application stored to memory 621.

Motion sensor 605 may comprise an accelerometer or any vibration sensing device for detecting motion of wireless terminal 600. Output from motion sensor 605 may be utilized by positioning module 623 for resolving a position of wireless terminal 623. Input from one or more proximity sensors 625 may also be utilized by positioning module 623 for resolving positioning of an associated user via, for example, triangulation and/or any other suitable position determination technique. Proximity sensors 625 can detect the presence of “nearby” objects via, for example, distortions in generated electromagnetic or electrostatic fields, electromagnetic radiation (e.g., infrared, radio frequency, intermediate frequency, etc.) beams, photoelectric beams, sound (e.g., ultrasonic) propagations, etc. In resolving relative positioning information corresponding to the nearby objects, positioning module 623 may also resolve its own relative position. This positioning information may be utilized to determine and/or optimize an AV system 100 configuration. Additional optimization input may be provided from condition sensor(s) 603. Condition sensors 603 may include a light sensor for detecting ambient lighting, an audio sensor for detecting background noise levels or interference fields, etc. As previously mentioned with respect to AV receiver 500, sensed information from proximity sensors 625 and/or condition sensor 603 may be utilized to “learn” attributes of the environment of AV system 100 or performance characteristics of AV system 100. This learned information may be stored to memory 621 and/or utilized to determine AV system configurations.

Accordingly, wireless terminal 600 may be implemented as any suitable remote controller or wireless one or two-way communicator. For example, wireless terminal 600 may be a cellular phone, a two-way trunked radio, a combination cellular phone and personal digital assistant (PDA), a smart phone, a cordless phone, a satellite phone, or any other suitable mobile device with telephony capabilities, such as a mobile computing device. Wireless terminal 600 may also correspond to suitable portable objects, devices, or appliances including a transceiver, such as a wireless fidelity (WiFi) transceiver, a worldwide interoperability for microwave access (WiMAX) transceiver, an infrared transceiver, Bluetooth transceiver, and the like.

FIG. 7 is a flowchart of a process 700 for creating an automated audio visual system user profile, according to an exemplary embodiment. At step 701, wireless terminal 600 executes an AV configuration application in response to user initialization. According to one embodiment, controller 619 implements instructions stored to memory 621 in response to, for example, user interaction with user interface 607, e.g., keypad 611, microphone 613, etc. Operation of controller 619 provides a graphical interface to the user via display 609. The graphical interface may include one or more input fields, menus, options, selections, etc., that enables the user to input user profile information to wireless terminal 600, per step 703. In other instances, however, wireless terminal 600 may initialize an AV configuration application of AV receiver 500 or control unit 400.

In any event, user profile information may include one or more user defined policies, AV configurations, control modes, predetermined spatial configurations, AV parameters, ambient conditions, and positioning information, as well as any other suitably configurable parameter, such as physical constraint information, ambient condition information, etc. User profile information may be input via user interface 607, e.g., keypad 611, microphone 613, etc. A user may be provided with the capability to download (or upload) user profile information to (or from) wireless terminal 600 via a wired (e.g., universal serial bus (USB), etc.) or wireless (e.g., infrared, wireless local area network, etc.) connection.

In step 705, the user profile information is stored to memory 621. This information can be uploaded (or synchronized) with a centralized memory of, for example, AV receiver 500. The AV configuration application may then continue to be executed via controller 619 as a background application. Alternatively, wireless terminal 600 can be set by the user to be operated in accordance with a time schedule, on-demand, based on sensed motion, or arbitrarily. At step 707, a triggering event invokes wireless terminal 600 to signal one or more components of AV environment 100 to configure AV environment 100. The relative location and/or spatial position of wireless terminal 600 may be conveyed during step 707.

The relative location and/or absolute spatial position of wireless terminal 600 may be resolved via proximity sensors 625, positioning module 623, controller 619, motion sensor 605, or a combination thereof. As one example, the spatial coordinates of wireless terminal 600 may be resolved via positioning module 623 triangulating sensed input (e.g., radio frequency, IF, IR, ultrasonic signaling) of proximity sensors 625. These spatial coordinates may be matched to stored coordinates for one or more predetermined or optimized AV system configurations.

FIGS. 8 and 9 are flowcharts of a process for transmitting configuration signals to automated bases, according to various exemplary embodiments. For the purposes of explanation, process 800 is described with respect to wireless terminal 600; however, it is to be appreciated that process 800 can be executed, in whole or in part, by AV receiver 500 and/or automated bases 200 and 300. At step 801, wireless terminal 600 initializes the AV system of AV environment 100, i.e., wireless terminal 600 “powers on” one or more components of AV system 100, such as, for example, display unit 101, the audio system (e.g., speakers 103-113), the AV receiver (e.g., AV receiver 500), and one or more automated bases (e.g., automated bases 200 and 300). In step 803, wireless terminal 600 determines a control mode for configuring AV system 100, such as a manual mode, in which user defined configuration information is utilized to spatially and/or electronically configure AV system 100, or an automatic mode in AV system 100 determines the configuration information to spatially and/or electronically configure AV system 100.

Controller 616 determines whether the control mode is a manual mode, per step 805. If it is a manual mode, then during step 807, wireless terminal 600 receives AV system configuration information from the user via user interaction with user interface 607. If it is not a manual mode, then it can be assumed to be an automatic configuration mode. Thus, positioning module 623, in step 809, determines position of an associated user by, for example, triangulating position of wireless terminal 600 via, for example, input provided by proximity sensors 625. According to particular embodiments, positioning information may be determined continuously, periodically, or on-demand. The positioning information may be historical or determined in real-time. In step 811, controller 619 determines whether additional AV system configuration inputs are obtainable.

If so, process 800 advances to process 900 of FIG. 9. Averting to FIG. 9, controller 619 determines, in step 901, whether user profile information is available, i.e., whether user profile information is stored within memory 621 or another suitable location, e.g., memory 511 of AV receiver 500. If user profile information is available, then controller 619 retrieves the user information from, for example, memory 621 or 511, per step 903. It is noted that user profile information may include user specific characteristics (e.g., height, eye sight capabilities, hearing capabilities, etc.), user identifications, AV system configuration information (e.g., audio parameters, display parameters, ambient condition parameters, etc.), AV system predetermined configuration modes (e.g., cleaning mode, storing mode, content specific mode, etc.), or any other suitable parameter. If no user profile information is available, then process 900 determines, at step 905, whether any ambient conditions can be detected, such as lighting conditions, background noise, interference fields, etc. If ambient conditions can be detected, then condition sensors 603, per step 907, determine (or otherwise detect) sensible ambient conditions. If no ambient conditions can be sensed, then process 900 determines, at step 909, whether the user has input any new parameters to override parameters to take into account for determining a configuration of AV system 100. If the user did provide new parameters, then controller 619 receives the override parameters via, for example, user interface 607. If no override parameters are available, then process 900 reverts to process 800, step 813. It is noted that any additional inputs received during process 900 may be utilized by controller 619 to determine and/or optimize an AV system configuration.

Referring back to FIG. 8, if no additional AV system configuration inputs are obtainable, then controller 619 determines a configuration for AV system 100 based on positioning information associated with a location of the user, per step 813. Based on the received configuration information or automatically determined AV system configuration, controller 619 generates, per step 815, one or more signals for configuring one or more components of AV system 100. These signals are transmitted to AV system 100, during step 817. In one embodiment, the signals are directly provided to the automated bases of display unit 101 and speakers 103-113. Additionally or alternatively, the signals may be provided to AV receiver 500 which then relays appropriate signals, configuration information, or control commands to implicated components of AV system 100. In step 819, controller 619 determines whether to terminate AV system configuration application. For example, if the user “powers down” display unit 101, the audio system (e.g., speakers 103-113), the AV receiver (e.g., AV receiver 500), and one or more automated bases (e.g., automated bases 200 and 300), then process 800 ends, otherwise the process reverts to step 803.

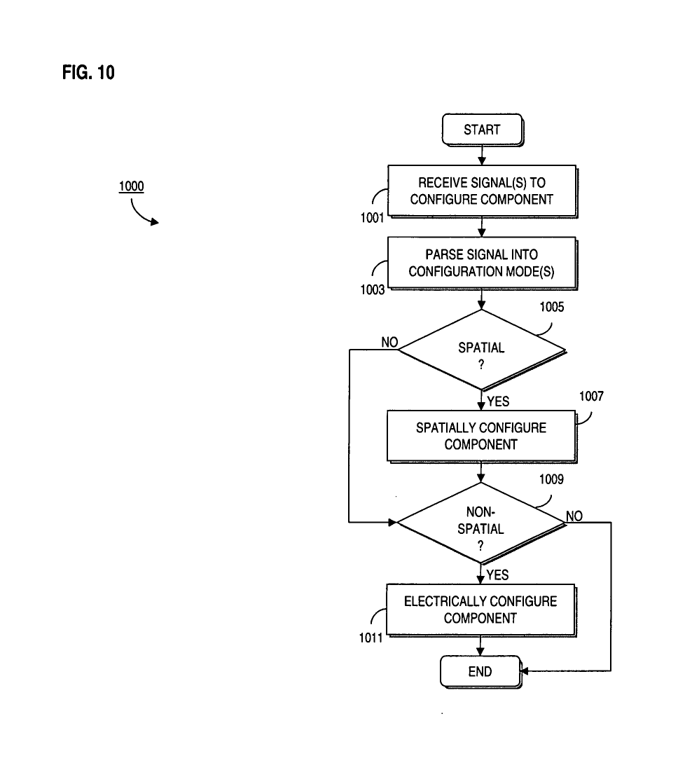

As will be become more apparent below, AV system configuration may include both spatial configuration and non-spatial, i.e., electronic, configuration for one or more components of AV system 100. FIG. 10 is a flowchart of a process for configuring a component of an automated audio visual system, according to an exemplary embodiment. At step 1001, an automated base (e.g., automated base 200) receives one or more signal(s) from, for example, wireless terminal 600 and/or AV receiver 500 to configure an AV component, such as display unit 101 or a speaker (e.g., center speaker 103). In step 1003, controller (or processor) 405 of control unit 400 parses and/or groups the received signal(s) into one or more configuration modes, i.e., spatial configuration (e.g., translational displacement and/or rotation movement) and non-spatial configuration (e.g., AV component settings) modes. In step 1005, controller 405 determines whether the received signal(s) include spatial configuration information (or commands). If there are, automated base spatially configures the AV component, per step 1007. That is controller 405 requests actuators to mechanically manipulate an associated automated base to transitionally displace or rotationally maneuver a supported AV component (e.g., display unit 101) into a suitable spatial condition. If there are no spatial configuration information (or commands), then in step 1009, controller 405 determines whether the received signal(s) include non-spatial configuration information (or commands). If there are, automated base electrically configures the AV component, per step 1011. That is, controller 405 ports the configuration information to the AV component via connectors 403. The associated AV component then implements the new electronic configuration, e.g., presentation settings of the AV component.

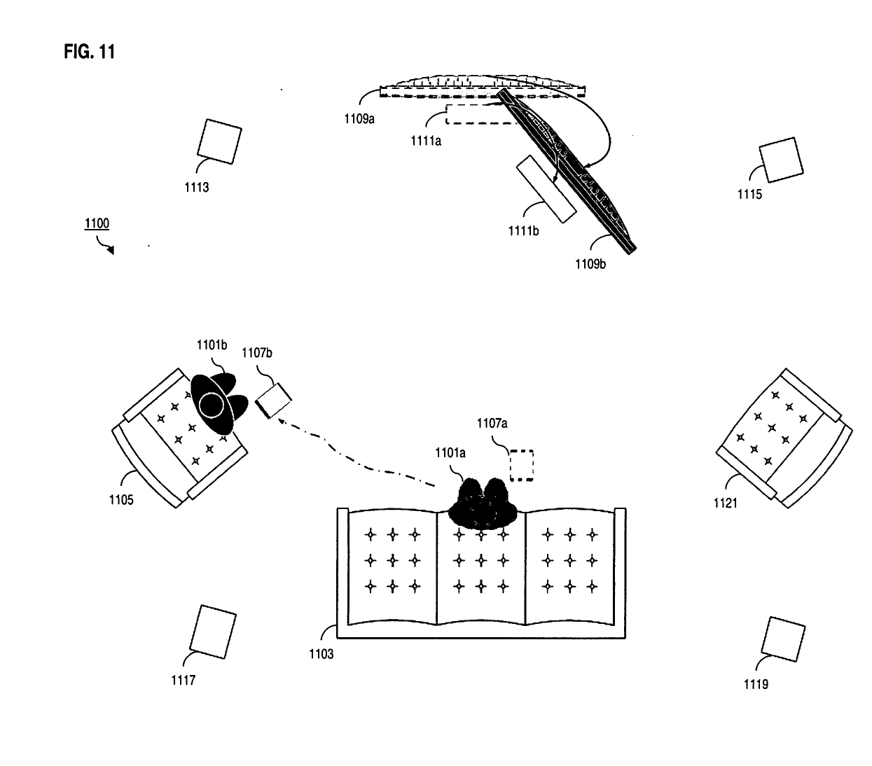

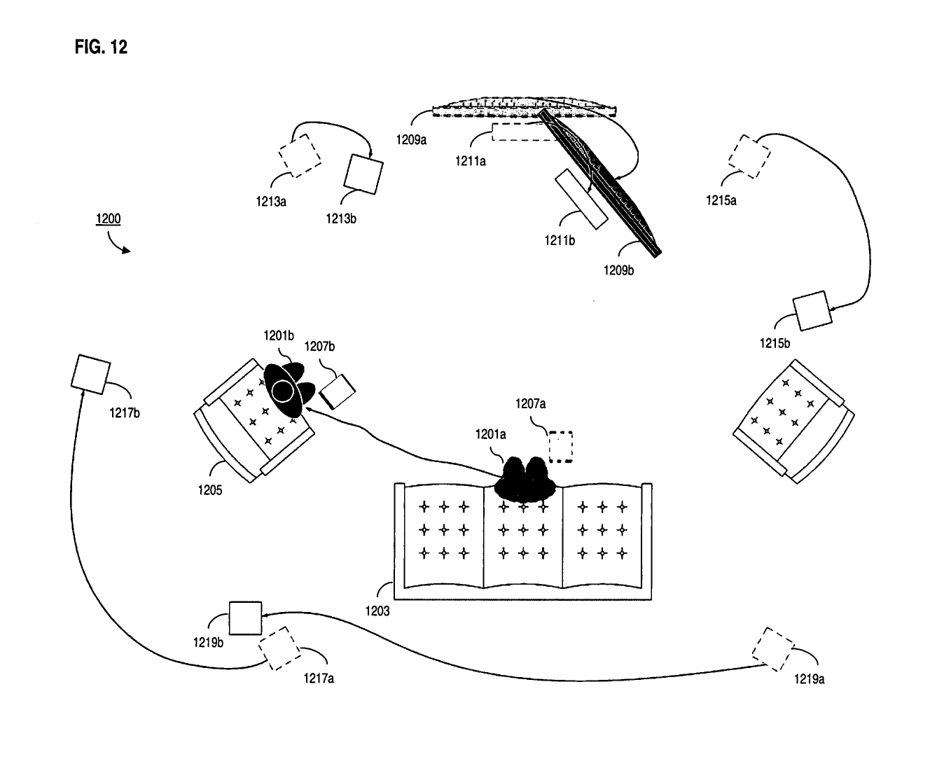

FIGS. 11 and 12 are schematic illustrations of configured automated audio visual systems, according to various exemplary embodiments. FIG. 11 is an exemplary spatial and non-spatial configuration 1100. As shown, a user moves from position 1101a at seat 1103 to position 1101b at seat 1105. Further, the user takes their associated wireless terminal (e.g., wireless terminal 600) with them. That is, the wireless terminal moves from position 1107a to position 1107b. Based on the movement of the wireless terminal, the wireless terminal, AV receiver (not shown), and/or automated bases (not shown) of the display unit and speakers of the audio system may determine a relative position of the wireless terminal. Based on this positioning information, an optimized AV system configuration is determined by, for example, a controller of the wireless terminal, and executed by the automated bases. As shown, the display unit is spatially configured from position 1109a to position 1109b. Meanwhile, the speakers are both spatially and non-spatially configured. That is, the center speaker is spatially configured from position 1111a to position 1111b. The left front speaker 1113 is electronically configured as a rear left speaker, and the right front speaker 1115 is electronically configured as a front left speaker. Similarly, the left rear speaker 1117 is electronically configured as a rear right speaker, and the right rear speaker 1119 is electronically configured as a front right speaker. In this manner, configuration 1100 can improve or optimize a user viewing experience, a user listening experience, or combination thereof.

FIG. 12 is an exemplary spatial-only configuration 1200. As shown, a user moves from position 1201a at seat 1203 to position 1201b at seat 1205. Further, the user takes their associated wireless terminal (e.g., wireless terminal 600) with them. That is, the wireless terminal moves from position 1207a to position 1207b. Based on the movement of the wireless terminal, the wireless terminal, AV receiver (not shown), and/or automated bases (not shown) of the display unit and speakers of the audio system may determine a relative position of the wireless terminal. Based on this positioning information, an optimized AV system configuration is determined by, for example, a controller of the wireless terminal, and executed by the automated bases. As shown, both the display unit and the speaker system are spatially configured. That is, the display unit is moved from position 1209a to position 1209b. Meanwhile, the speaker unit has also been automatically displaced and/or rotated from its original location. Namely, the center speaker is moved from position 1211a to position 1211b. The left front speaker is moved from position 1213a to position 1213b. The right front speaker is moved from positioned 1215a to position 1215b. The lift rear speaker is moved from position 1217a to position 1217b. The right rear speaker is moved from position 1219a to position 1219b. In this manner, configuration 1200 can improve or optimize a user viewing experience, a user listening experience, or combination thereof.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein.

What is claimed is:

1. A method comprising:
obtaining positioning information corresponding to a location of a user;
determining a spatial configuration for an audio visual system in relation to the positioning information; and
generating a signal for spatially adjusting one or more components of the audio visual system,
wherein the audio visual system is reconfigured in accordance with the generated signal.

2. A method as recited in claim 1, further comprising:
receiving user originated configuration information; and
changing the reconfigured system in response to the received user configuration information.

3. A method as recited in claim 1, wherein the step of determining further comprises:
sensing a performance characteristic of the audio visual system; and
formulating a spatial or electronic adjustment for optimizing the performance characteristic.

4. A method as recited in claim 3, wherein the performance characteristic is related to user viewing experience, user listening experience, or combination thereof.

5. A method as recited in claim 1, further comprising:
receiving physical constraint information associated with the audio visual system environment,
wherein the step of reconfiguring comprises evaluating the physical constraint information.

6. A method as recited in claim 1, wherein the step of obtaining further comprises:
receiving a position identification signal from a location proximate the user.

7. A method as recited in claim 6, wherein the position identification signal is continuously generated during use of the audio visual system.

8. A method as recited in claim 1, further comprising:
detecting presence of the user; and
retrieving, in response to detection, user profile information of the user;
wherein the user profile information is related to one or more audio parameters or one or more visual parameters of the system.

9. A method as recited in claim 1, wherein the step of reconfiguring comprises applying a translational displacement to a system component.

10. A method as recited in claim 1, wherein the step of reconfiguring comprises rotating a system component.

11. A method as recited in claim 1, further comprising:
detecting an ambient condition,
wherein the step of reconfiguring comprises evaluating the ambient condition.

12. An apparatus comprising:
a processor; and
a communication interface;
wherein the processor is configured to determine a spatial configuration for an audio visual system based on positioning of a user, and the communication interface is configured to communicate with the audio visual system for spatially configuring one or more components of the audio visual system based on the spatial configuration.

13. An apparatus as recited in claim 12, further comprising:
a positioning module,
wherein the positioning module is configured to resolve positioning of the user in real-time.

15. An apparatus as recited in claim 12, further comprising:
a sensor,
wherein the sensor is configured to detect an ambient condition, and the processor is further configured to further determine the spatial configuration based on the ambient condition.

16. An apparatus as recited in claim 12, wherein the processor is further configured to determine the spatial configuration to optimize a viewing experience, a listening experience, or a combination thereof.

17. An apparatus as recited in claim 12, further comprising:
a memory,
wherein the memory is configured to store user profile information, the user profile information including information for spatially configuring the one or more components, information for configuring one or more audio parameters of the one or more components, information for configuring one or more visual parameters of the one or more components, or a combination thereof.

18. An apparatus as recited in claim 12, further comprising:
a user interface configured to enable the user to create one or more predefined spatial configurations to override the spatial configuration, or manipulate at least a portion of the spatial configuration.

19. A system comprising:
a receiver; and
a wireless terminal,
wherein the receiver is configured to detect a proximity of the wireless terminal, to determine, based on the proximity, a spatial configuration for an audio visual device that optimizes a multimedia experience, and to signal an automated structure configured to spatially configure the audio visual device based on the spatial configuration.

20. A system as recited in claim 19, wherein the wireless terminal is associated with a user, and the receiver is further configured to retrieve user profile information of the user and to configure the audio visual device based on the user profile information, the user profile information including one or more audio settings, one or more visual settings, or a combination thereof.
